(19) United States
(12) Patent Application Publication
(10) Pub. No.: US 2014/0334199 A1
(43) Pub. Date: Nov. 13, 2014

(54) Five-Level Power Converter, and Control Method and Control Apparatus for the Same

(71) Applicant: Huawei Technologies Co., Ltd., Shenzhen (CN)

(72) Inventors: Bo He, Shenzhen (CN); Dianbo Fu, Plano, TX (US); Yihang Lv, Shenzhen (CN)

(21) Appl. No.: 14/328,992

(22) Filed: Jul. 11, 2014

Related U.S. Application Data
(63) Continuation of application No. PCT/CN2013/073818, filed on Apr. 7, 2013.

(30) Foreign Application Priority Data
Jun. 30, 2012 (CN) 201210222899.2

(51) Int. Cl. H02M 5/458

(52) U.S. Cl. CPC H02M 5/4585
USPC 363/37

(57) ABSTRACT

A five-level power converter and a control method for the same are provided. The five-level power converter includes an inverter and at least a rectifier, where the rectifier includes at least one rectifier control circuit and four capacitors which are divided into two groups, each with two capacitors connected in parallel, where a first end of a first capacitor to a fourth capacitor is grounded; the rectifier control circuit is configured to input a current to a second end of the first capacitor to the fourth capacitor; and a polarity of charges accumulated at the second ends of the first capacitor and the second capacitor is opposite to a polarity of charges accumulated at the second ends of the third capacitor and the fourth capacitor; and the inverter includes a discharge control circuit, and a first inductor unit and a first load connected in series.

### CROSS-REFERENCE TO RELATED APPLICATIONS

This application is a continuation of International Application No. PCT/CN2013/073818, filed on Apr. 7, 2013, which claims priority to Chinese Patent Application No. 201210222899.2, filed on Jun. 30, 2012, all of which are hereby incorporated by reference in their entireties.

### STATEMENT REGARDING FEDERALLY SPONSORED RESEARCH OR DEVELOPMENT

Not applicable.

### REFERENCE TO A MICROFICHE APPENDIX

Not applicable.

### TECHNICAL FIELD

The present invention relates to power conversion technologies, and in particular, to a five-level power converter and a control method and a control apparatus for the same.

### BACKGROUND

An uninterruptible power system (UPS) is a power converter with a constant voltage and frequency, which includes an energy storage apparatus and has a rectifier and an inverter as major components. The UPS is mainly used to supply uninterruptible power to a single computer, a computer network system, or other electric and electronic devices. When the mains input is normal, the UPS stabilizes the mains and supplies power to a load. In this case, the UPS acts as an alternating current mains voltage stabilizer and also charges an internal energy storage apparatus. When the mains is interrupted, the UPS immediately uses electric energy stored in the internal energy storage apparatus to continuously supply alternating current power to the load by using an inverse transform approach, so that the load remains working properly.

The rectifier of the power inverter implements a power factor correction (PFC) function in working mode of the mains, and boosts a voltage to a direct current BUS voltage in discharge mode. The inverter converts the direct current BUS voltage to an alternating current voltage and provides it for the load. Generally, the rectifier is implemented by a double-boost Boost circuit or a Vienna rectifier, and the inverter may be a common two-level half/full-bridge inverter or a three-level neutral-point clamped inverter.

A power converter in the prior art can only be used for four-level power conversion to output a four-level voltage.

### SUMMARY

In view of the above-mentioned defects in the prior art, embodiments of the present invention provide a five-level power converter and a control method to implement a five-level working mode.

In one aspect, an embodiment of the present invention provides a five-level power converter, including an inverter and at least one rectifier. The rectifier includes a rectifier control circuit, a first capacitor and a second capacitor connected in parallel, and a third capacitor and a fourth capacitor connected in parallel, where a first end of the first capacitor, a first end of the second capacitor, a first end of the third capacitor, and a first end of the fourth capacitor are grounded.

The rectifier control circuit is configured to input current to a second end of the first capacitor, a second end of the second capacitor, a second end of the third capacitor, and a second end of the fourth capacitor; polarities of charges accumulated at the second end of the first capacitor and at the second end of the second capacitor are the same, and the amount of electricity accumulated at the second end of the first capacitor is greater than the amount of electricity accumulated at the second end of the second capacitor; polarities of charges accumulated at the second end of the third capacitor and at the second end of the fourth capacitor are the same, and the amount of electricity accumulated at the second end of the fourth capacitor is greater than the amount of electricity accumulated at the second end of the third capacitor; and a polarity of charges accumulated at the second ends of the first capacitor and the second capacitor is opposite to a polarity of charges accumulated at the second ends of the third capacitor and the fourth capacitor.

The inverter includes a discharge control circuit, and a first inductor unit and a first load connected in series, where a first end of the inductor unit is connected to a first end of the first load, and a second end of the first load is grounded; and the discharge control circuit is configured to discharge sequentially from a second end of the second capacitor, a second end of the first capacitor, a second end of the third capacitor, and a second end of the fourth capacitor of the rectifier, where a discharge current flows through the first inductor unit and the first load connected in series, and the charging and discharging of any of the first capacitor, the second capacitor, the third capacitor, and the fourth capacitor are staggered.

Optionally, the rectifier control circuit includes a second inductor unit, a first switching circuit, a first control circuit, and a second control circuit, where a first end of the second inductor unit is connected to an external input power supply.

The first control circuit includes a third diode, a fourth diode, and a third switch transistor, where the third diode is connected in series to a circuit between the second end of the first capacitor and a second end of the second inductor unit, an anode of the third diode is connected to the second end of the second inductor unit, and a cathode of the third diode is connected to the second end of the first capacitor; and the fourth diode and the third switch transistor are connected in series in a circuit between the second end of the second capacitor and the second end of the second inductor unit, and an anode of the fourth diode is connected to the second end of the second inductor unit.

The second control circuit includes a fifth diode, a sixth diode, and a fourth switch transistor, where the fifth diode is connected in series to a circuit between the second end of the fourth capacitor and the second end of the second inductor unit, an anode of the fifth diode is connected to the second end of the second inductor unit, and a cathode of the fifth diode is connected to the second end of the fourth capacitor; and the sixth diode and the fourth switch transistor are connected in series to a circuit between the second end of the third capacitor and the second end of the second inductor unit, and an anode of the sixth diode is connected to the second end of the second inductor unit.

The first switching circuit is configured to switch the flow of an energy storage current provided by the external input power supply from the first end to the second end of the second inductor unit or from the second end to the first end of the second inductor unit.

Alternatively, the first switching circuit includes a first switch transistor and a second switch transistor connected in series, and a first diode and a second diode connected in series, where polarities of the first diode and the second diode are set oppositely, and the point between the first switch transistor and the second switch transistor are in communication with the point between the first diode and the second diode.

In addition, the external input power supply includes an external alternating current input power supply and a battery group, where the external alternating current input power supply is connected to the first end of the second inductor unit by using an alternating current switch component.

When the rectifier includes a rectifier control circuit, the battery group includes a first battery unit and a second battery unit, where an anode of the first battery unit is connected to the first end of the second inductor unit in the rectifier control circuit by using a direct current switch component, and a cathode of the first battery unit is grounded; a cathode of the second battery unit is connected to the first end of the second inductor unit in the rectifier control circuit by using a direct current switch component, and an anode of the second battery unit is grounded.

Alternatively, when a first rectifier and a second rectifier are included, the battery group includes a third battery unit and a fourth battery unit, where an anode of the third battery unit is connected to the first end of the second inductor unit of the first rectifier by using a direct current switch component, and a cathode of the third battery unit is grounded; a cathode of the fourth battery unit is connected to the first end of the second inductor unit of the second rectifier by using a direct current switch component, and an anode of the fourth battery unit is grounded.

The rectifier control circuit includes a third inductor unit, a fourth inductor unit, a second switching circuit, a third control circuit, and a fourth control circuit, where a first end of the third inductor unit and a first end of the fourth inductor unit are connected to an external input power supply.

The third control circuit includes a seventh diode, an eighth diode, and a fifth switch transistor, where the seventh diode is connected in series to a circuit between the second end of the first capacitor and a second end of the third inductor unit, an anode of the seventh diode is connected to the second end of the third inductor unit, and a cathode of the seventh diode is connected to the second end of the first capacitor; the eighth diode and the fifth switch transistor are connected in series to a circuit between the second end of the second capacitor and the second end of the third inductor unit, and an anode of the eighth diode is connected to the second end of the third inductor unit.

The fourth control circuit includes a ninth diode, a tenth diode, and a sixth switch transistor, where the ninth diode is connected in series to a circuit between the second end of the fourth capacitor and a second end of the fourth inductor unit, an anode of the ninth diode is connected to the second end of the fourth inductor unit, and a cathode of the ninth diode is connected to the second end of the fourth capacitor; the tenth diode and the sixth switch transistor are connected in series to a circuit between the second end of the third capacitor and the second end of the fourth inductor unit, and an anode of the tenth diode is connected to the second end of the fourth inductor unit.

The second switching circuit is configured to switch the flow of an energy storage current provided by an external input power supply from the first end to the second end of the third inductor unit or from the second end to the first end of the fourth inductor unit.

Alternatively, the second switching circuit includes a seventh switch transistor and an eighth switch transistor, where one end of the seventh switch transistor is connected to the second end of the third inductor unit, and the other end of the seventh switch transistor is grounded; and one end of the eighth switch transistor is connected to the second end of the fourth inductor unit, and the other end of the eighth switch transistor is grounded.

Alternatively, the external input power supply includes an external alternating current input power supply or a battery group, where the external input power supply and the first end of the third inductor unit, as well as the external alternating current input power supply and the first end of the fourth inductor unit, are connected by using an alternating current switch component.

The battery group includes a fifth battery unit and a sixth battery unit, where an anode of the fifth battery unit is connected to the first end of the third inductor unit by using a direct current switch component, and a cathode of the fifth battery unit is grounded; a cathode of the sixth battery unit is connected to the first end of the fourth inductor unit by using a direct current switch component, and an anode of the sixth battery unit is grounded.

Alternatively, the first inductor unit, the second inductor unit, the third inductor unit, or the fourth inductor unit may be formed by: a single inductor component, or multiple inductor components connected in parallel, or multiple inductor components connected in series.

The discharge control circuit in the above embodiment includes a ninth switch transistor, a tenth switch transistor, an eleventh switch transistor, a twelfth switch transistor, a thirteenth switch transistor, a fourteenth switch transistor, and a third switching circuit.

A first end of the ninth switch transistor is connected to the second end of the first capacitor, a second end of the ninth switch transistor is connected to a first end of the tenth switch transistor, a second end of the tenth switch transistor is connected to the second end of the first inductor unit, a first end of the eleventh switch transistor is connected to the second end of the second capacitor, and a second end of the eleventh switch transistor is connected to the first end of the tenth switch transistor; a first end of the fourteenth switch transistor is connected to the second end of the fourth capacitor, a second end of the fourteenth switch transistor is connected to the first end of the thirteenth switch transistor, a second end of the thirteenth switch transistor is connected to the second end of the first inductor unit, a first end of the twelfth switch transistor is connected to the second end of the third capacitor, and a second end of the twelfth switch transistor is connected to the second end of the fourteenth switch transistor.

A first end of the third switching circuit is connected to the second end of the first inductor unit, and a second end of the third switching circuit is grounded, so as to implement forward conduction from the second end to the first end of the third switching circuit or reverse conduction from the first end to the second end of the third switching circuit by time.

In another aspect, an embodiment of the present invention provides a control method of the above five-level power converter. The control method for the five-level power converter includes: controlling the rectifier control circuit to input a current to the second end of the first capacitor, the second end of the second capacitor, the second end of the third capacitor, and the second end of the fourth capacitor, where polarities of charges accumulated at the second end of the first capacitor and the second end of the second capacitor are the same, and the amount of electricity accumulated at the second end of the first capacitor is greater than the amount of electricity accumulated at the second end of the second capacitor; polarities of charges accumulated at the second end of the third capacitor and the second end of the fourth capacitor are the same, and the amount of electricity accumulated at the second end of the fourth capacitor is greater than the amount of electricity accumulated at the second end of the third capacitor; and a polarity of charges accumulated at the second ends of the first capacitor and the second capacitor is opposite to a polarity of charges accumulated at the second ends of the third capacitor and the fourth capacitor; and controlling the discharge control circuit to discharge sequentially from the second end of the second capacitor, the second end of the first capacitor, the second end of the third capacitor, and the second end of the fourth capacitor of the rectifier, where a discharge current flows through the first inductor unit and the first load connected in series, and the charging and discharging of any of the first capacitor, the second capacitor, the third capacitor, and the fourth capacitor are staggered.

In still another aspect, an embodiment of the present invention provides a control apparatus of the above five-level power converter. The apparatus includes: a rectifier control module configured to control the rectifier control circuit to input a current to the second end of the first capacitor, the second end of the second capacitor, the second end of the third capacitor, and the second end of the fourth capacitor, where polarities of charges accumulated at the second end of the first capacitor and the second end of the second capacitor are the same, and the amount of electricity accumulated at the second end of the first capacitor is greater than the amount of electricity accumulated at the second end of the second capacitor; polarities of charges accumulated at the second end of the third capacitor and the second end of the fourth capacitor are the same, and the amount of electricity accumulated at the second end of the fourth capacitor is greater than the amount of electricity accumulated at the second end of the third capacitor; and a polarity of charges accumulated at the second ends of the first capacitor and the second capacitor is opposite to a polarity of charges accumulated at the second ends of the third capacitor and the fourth capacitor; and an inverter control module configured to control the discharge control circuit to discharge sequentially from the second end of the second capacitor, the second end of the first capacitor, the second end of the third capacitor, and the second end of the fourth capacitor of the rectifier, where a discharge current flows through the first inductor unit and the first load connected in series, and the charging and discharging of any of the first capacitor, the second capacitor, the third capacitor, and the fourth capacitor are staggered.

Embodiments of the present invention provide a five-level power converter and a control method and a control apparatus for the same. The five-level power converter includes an inverter and at least one rectifier, where the rectifier includes a rectifier control circuit, a first capacitor and a second capacitor connected in parallel, and a third capacitor and a fourth capacitor connected in parallel, where a first end of the first capacitor, a first end of the second capacitor, a first end of the third capacitor, and a first end of the fourth capacitor are grounded; and the rectifier control circuit is capable of charging the first capacitor, the second capacitor, the third capacitor, and the fourth capacitor, so that polarities of charges accumulated at the second end of the first capacitor and the second end of the second capacitor are the same, and the amount of electricity accumulated at the second end of the first capacitor is greater than the amount of electricity accumulated at the second end of the second capacitor; polarities of charges accumulated at the second end of the third capacitor and the second end of the fourth capacitor are the same, and the amount of electricity accumulated at the second end of the fourth capacitor is greater than the amount of electricity accumulated at the second end of the third capacitor; and a polarity of charges accumulated at the second ends of the first capacitor and the second capacitor is opposite to a polarity of charges accumulated at the second ends of the third capacitor and the fourth capacitor. A discharge control circuit of the inverter is configured to discharge sequentially from the second end of the second capacitor, the second end of the first capacitor, the second end of the third capacitor, and the second end of the fourth capacitor of the rectifier, thereby implementing a five-level working mode.

### BRIEF DESCRIPTION OF THE DRAWINGS

To illustrate the technical solutions in the embodiments of the present invention more clearly, the following briefly introduces the accompanying drawings required for describing the embodiments. The accompanying drawings in the following description show merely some embodiments of the present invention, and a person of ordinary skill in the art may still derive other drawings from these accompanying drawings without creative efforts.

FIG. 1 is a circuit architecture diagram of a five-level power converter according to a first embodiment of the present invention;

FIG. 2 is a circuit architecture diagram of a five-level power converter according to a second embodiment of the present invention;

FIG. 3 is a circuit architecture diagram of a five-level power converter according to a third embodiment of the present invention;

FIG. 4 is a circuit architecture diagram of a five-level power converter according to a fourth embodiment of the present invention;

FIG. 5 is a flowchart of a control method for a five-level power converter according to a first embodiment of the present invention;

FIG. 6 is a flowchart of a control method for a five-level power converter according to a second embodiment of the present invention;

FIG. 7 is a flowchart of a control method for a five-level power converter according to a third embodiment of the present invention;

FIG. 8 is a flowchart of a control method for a five-level power converter according to a fourth embodiment of the present invention;

FIG. 9 is a schematic diagram of a working voltage waveform for a control method for a five-level power converter according to a fourth embodiment of the present invention;

FIG. 10 is a structural schematic diagram of a control apparatus for a five-level power converter according to a first embodiment of the present invention;

FIG. 11 is a structural schematic diagram of a control apparatus for a five-level power converter according to a second embodiment of the present invention;

FIG. 12 is a structural schematic diagram of a control apparatus for a five-level power converter according to a third embodiment of the present invention; and

FIG. 13 is a structural schematic diagram of a control apparatus for a five-level power converter according to a fourth embodiment of the present invention.

### DETAILED DESCRIPTION

To make the objectives, technical solutions, and advantages of the embodiments of the present invention more comprehensible, the following clearly and completely describes the technical solutions in the embodiments of the present invention with reference to the accompanying drawings in the embodiments of the present invention. The described embodiments are merely a part rather than all of the embodiments of the present invention. All other embodiments obtained by a person of ordinary skill in the art based on the embodiments of the present invention without creative efforts shall fall within the protection scope of the present invention.

A five-level power converter and a control method provided in embodiments of the present invention may implement operations in five levels and may be applied to a UPS system. When a system works with an alternating current power supply, a rectifier of the five-level power converter may convert an input alternating current to a direct current and implement an input PFC function; when the alternating current power supply is interrupted, the five-level power converter immediately uses electric energy stored in an internal energy storage apparatus to continuously supply alternating current power to a load by using an inverse transform approach, so that the load keeps working properly.

A power conversion topology of the five-level power converter provided in an embodiment of the present invention is formed by a rectifier and an inverter. The rectifier is configured to convert an input alternating current to a direct current and implement a PFC function. The inverter is configured to invert the direct current voltage after rectification to an alternating current output voltage.

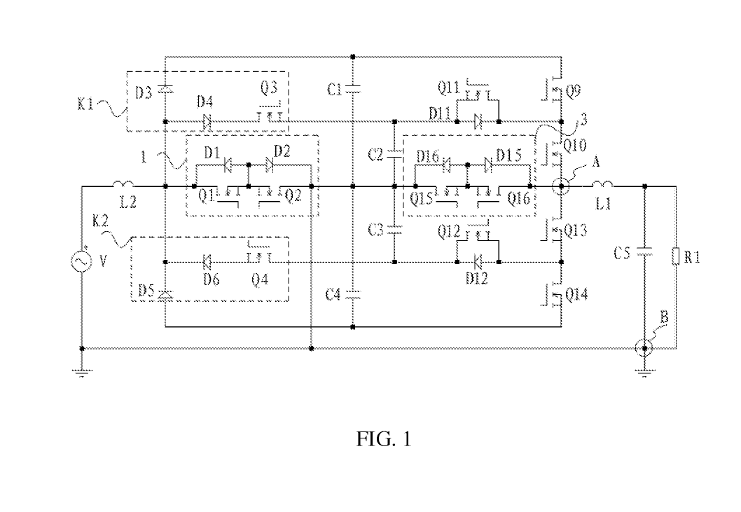

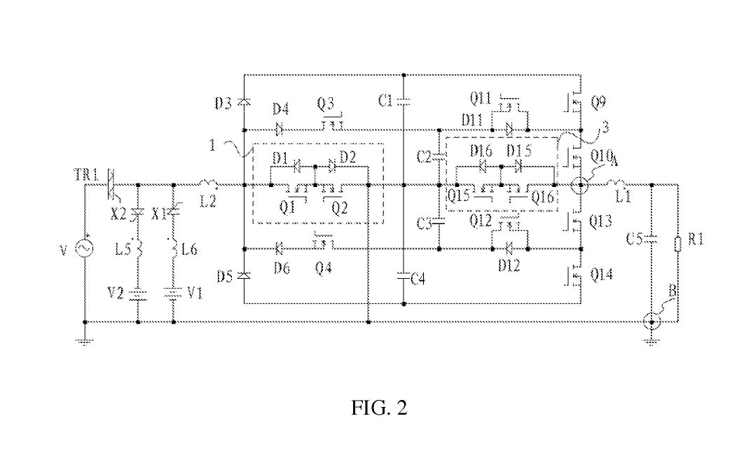

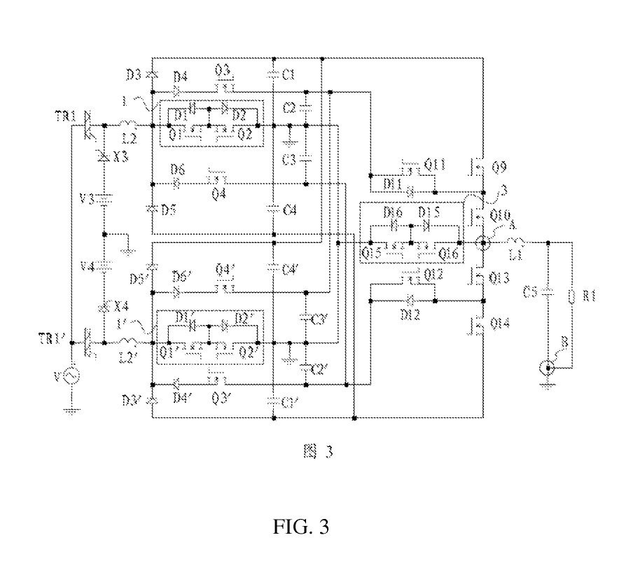

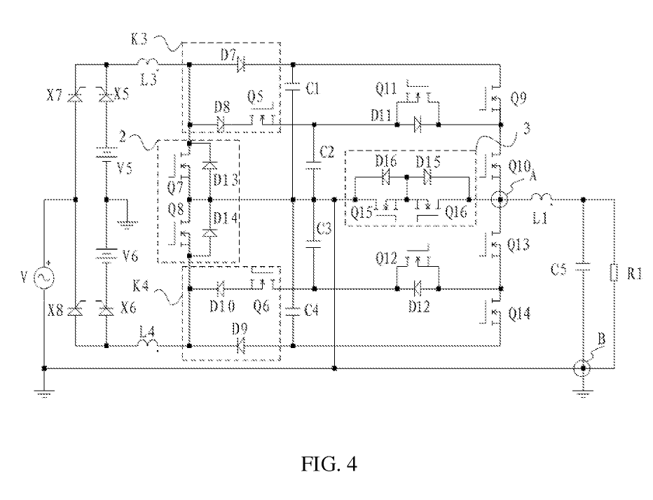

FIG. 1 is a circuit architecture diagram of a five-level power converter according to a first embodiment of the present invention; FIG. 2 is a circuit architecture diagram of a five-level power converter according to a second embodiment of the present invention; FIG. 3 is a circuit architecture diagram of a five-level power converter according to a third embodiment of the present invention; and FIG. 4 is a circuit architecture diagram of a five-level power converter according to a fourth embodiment of the present invention. As shown in FIG. 1, FIG. 2, FIG. 3, or FIG. 4, the five-level power converter provided in an embodiment of the present invention includes an inverter and at least one rectifier, where the rectifier includes a rectifier control circuit, a first capacitor C1 and a second capacitor C2 connected in parallel, and a third capacitor C3 and a fourth capacitor C4 connected in parallel, where a first end of the first capacitor C1, a first end of the second capacitor C2, a first end of the third capacitor C3, and a first end of the fourth capacitor C4 are grounded.

The rectifier control circuit is configured to input a current to a second end of the first capacitor C1, a second end of the second capacitor C2, a second end of the third capacitor C3, and a second end of the fourth capacitor C4; polarities of charges accumulated at the second end of the first capacitor C1 and the second end of the second capacitor C2 are the same, and the amount of electricity accumulated at the second end of the first capacitor C1 is greater than the amount of electricity accumulated at the second end of the second capacitor C2; polarities of charges accumulated at the second end of the third capacitor C3 and the second end of the fourth capacitor C4 are the same, and the amount of electricity accumulated at the second end of the fourth capacitor C4 is greater than the amount of electricity accumulated at the second end of the third capacitor C3; a polarity of charges accumulated at the second ends of the first capacitor C1 and the second capacitor C2 is opposite to a polarity of charges accumulated at the second ends of the third capacitor C3 and the fourth capacitor C4.

The inverter includes a discharge control circuit, and a first inductor unit L1 and a first load R1 connected in series, where a first end of the first inductor unit L1 is connected to a first end of the first load R1, a second end of the first load R1 is grounded, and a fifth capacitor C5 is connected to the first load in parallel. The discharge control circuit is configured to discharge sequentially from the second end of the second capacitor C2, the second end of the first capacitor C1, the second end of the third capacitor C3, and the second end of the fourth capacitor C4 of the rectifier, where a discharge current flows through the first inductor unit L1 and the first load R1 connected in series, and the charging and discharging of any of the first capacitor C1, the second capacitor C2, the third capacitor C3, and the fourth capacitor C4 are staggered.

The five-level power converter according to a first embodiment of the present invention implements five-level output and implements an input PFC function by using a rectifier control circuit of its rectifier and a discharge control circuit of its inverter.

In the five-level power converter provided in the above embodiment of the present invention, the rectifier control circuit of the rectifier may have multiple composition forms. For example, as shown in FIG. 1, the rectifier control circuit includes a second inductor unit L2, a first switching circuit 1, a first control circuit K1, and a second control circuit K2, where a first end of the second inductor unit L2 is connected to an external input power supply.

The first control circuit K1 includes a third diode D3, a fourth diode D4, and a third switch transistor Q3, where the third diode D3 is connected in series in a circuit between the second end of the first capacitor C1 and a second end of the second inductor unit L2, an anode of the third diode D3 is connected to the second end of the second inductor unit L2, and a cathode of the third diode D3 is connected to the second end of the first capacitor C1; and the fourth diode D4 and the third switch transistor Q3 are connected in series in a circuit between the second end of the second capacitor C2 and the second end of the second inductor unit L2, and an anode of the fourth diode D4 is connected to the second end of the second inductor unit L2.

The second control circuit K2 includes a fifth diode D5, a sixth diode D6, and a fourth switch transistor Q4, where the fifth diode D5 is connected in series to a circuit between the second end of the fourth capacitor C4 and the second end of the second inductor unit L2, an anode of the fifth diode D5 is connected to the second end of the second inductor unit L2, and a cathode of the fifth diode D5 is connected to the second end of the fourth capacitor C4; and the sixth diode D6 and the fourth switch transistor Q4 are connected in series to a circuit between the second end of the second capacitor C3 and the second end of the second inductor unit L2, and an anode of the sixth diode D6 is connected to the second end of the second inductor unit L2.

The first switching circuit 1 is configured to switch the flow of an energy storage current provided by the external input power supply from the first end to the second end of the second inductor unit L2 or from the second end to the first end of the second inductor unit L2.

In the five-level power converter provided in an embodiment of the present invention, the first switching circuit 1 includes a first switch transistor Q1 and a second switch transistor Q2 connected in series, and a first diode D1 and a second diode D2 connected in series, where polarities of the first diode D1 and the second diode D2 are set oppositely, and the point between the first switch transistor Q1 and the second switch transistor Q2 are in communication with the point between the first diode D1 and the second diode D2.

In the five-level power converter according to an embodiment of the present invention, the five-level rectifier adds, based on a general Vienna rectifier, a tributary for each of positive and negative BUS voltages, where a third switch transistor Q3 and a fourth diode D4 form a positive BUS voltage tributary and a fourth switch transistor Q4 and a sixth diode D6 form a negative BUS voltage tributary; the five-level inverter adds, based on a general type-I three-level neutral-point clamped inverter, two tributaries, where an eleventh switch transistor Q11 correspondingly outputs a positive half cycle of a sine wave and a twelfth switch transistor Q12 correspondingly outputs a negative half cycle of the sine wave.

Optionally, each switch transistor in the above embodiment may be a metal-oxide-semiconductor field-effect transistor (MOSFET), an insulated gate bipolar transistor (IGBT), or another switch component. There may be one switch transistor, or multiple switch transistors connected in series, or connected in parallel in a direct manner or in an interleaved manner in a circuit.

Each diode of the rectifier may be a general diode or a switch component such as MOSFET and IGBT for synchronous rectification. There may be one diode or multiple diodes connected in series or in parallel.

The second inductor unit of the rectifier may be formed by one inductor unit or multiple inductor units connected in parallel or in series.

In the five-level power converter provided in an embodiment of the present invention, the five-level rectifier is improved based on a general Vienna rectifier, which implements operations in five levels while maintaining the high efficiency of a Vienna rectifier. Because operations in five levels are supported, a PFC inductance may be further reduced.

As shown in FIG. 2, in a five-level power converter according to a second embodiment of the present invention, an external input power supply includes an external alternating current input power supply V and a battery group, where the external alternating current input power supply V is connected to a first end of a second inductor unit L2 by using an alternating current switch component TR1.

In this embodiment, the rectifier includes a rectifier control circuit, and the battery group includes a first battery unit V1 and a second battery unit V2, where an anode of the first battery unit V1 is connected to the first end of the second inductor unit L2 in the rectifier control circuit by using a direct current switch component X1, and a cathode of the first battery unit V1 is grounded; a cathode of the second battery unit V2 is connected to the first end of the second inductor unit L2 in the rectifier control circuit by using a direct current switch component X2, and an anode of the second battery unit V2 is grounded.

This embodiment improves the circuit in FIG. 1 by adding an alternating current switch component TR1, a direct current switch component X1, and a direct current switch component X2 for the input alternating current power or battery switching circuit, to form the schematic circuit diagram of a power converter according to a second embodiment shown in FIG. 2. A fifth inductor unit L3 and a sixth inductor unit L4 connected in series to two groups of battery units implement current conversion and smoothing.

The working principle of the circuit in this embodiment is similar to that illustrated in FIG. 1. The difference is that a set of five-level rectifier is shared after an alternating current and a battery switching circuit is added. In alternating current power supply mode, the five-level rectifier implements a PFC function; in battery mode, the five-level rectifier implements a direct current boost function.

According to the above embodiment of the present invention, in battery mode, the first battery unit V1 and the second battery unit share one boost circuit. In the case of switching, if circuit parasitic or a control signal exception occurs, the two groups of batteries may be directly short-circuited. To avoid such a risk, an overcurrent protection fuse may be added to each battery unit. In addition, a fifth inductor unit L5 and a sixth inductor unit L6 may be further added to implement current conversion and smoothing.

As shown in FIG. 3, in a five-level power converter according to a third embodiment of the present invention, an external input power supply includes an external alternating current input power supply V and a battery group, where the external alternating current input power supply V is connected to a first end of a second inductor unit L2 by using an alternating current switch component TR1.

In this embodiment, two rectifiers are included, that is, a first rectifier and a second rectifier, and the battery group includes a third battery unit V3 and a fourth battery unit V4, where an anode of the third battery unit V3 is connected to the first end of the second inductor unit L2 of the first rectifier by using a direct current switch component X3, and a cathode of the third battery unit V3 is grounded; and a cathode of the fourth battery unit V4 is connected to the first end of the second inductor unit L2 of the second rectifier by using a direct current switch component X4, and an anode of the fourth battery unit V4 is grounded.

This embodiment further implements the circuit illustrated in FIG. 2 and uses two sets of rectifiers to form the schematic circuit diagram of a five-level power converter according to a third embodiment shown in FIG. 3.

The working principle of the circuit according to this embodiment is similar to that shown in FIG. 2. The difference is that in battery mode, when the third battery unit V3 and the fourth battery unit V4 work, they use two sets of independent five-level rectifiers, respectively, there is no risk in battery switching. In addition, in alternating current power supply mode, the two sets of five-level rectifiers may be connected in parallel, in a direct manner or in an interleaved manner, thereby reducing the conduction loss of power switch transistors and improving efficiency.

The above circuit rectifier is formed by a single-inductor dual-output double-boost or Vienna rectifier that uses diodes and power switch transistors to form a switching tributary: a high voltage output in a main circuit and a low voltage output in the tributary.

As shown in FIG. 4, in a five-level power converter according to a fourth embodiment of the present invention, the rectifier control circuit includes a third inductor unit L3, a fourth inductor unit L4, a second switching circuit 2, a third control circuit K3, and a fourth control circuit K4, where a first end of the third inductor unit L3 and a first end of the fourth inductor L4 unit are connected to an external input power supply.

The third control circuit K3 includes a seventh diode D7, an eighth diode D8, and a fifth switch transistor Q5, where the seventh diode D7 is connected in series in a circuit between the second end of the first capacitor C1 and a second end of the third inductor unit L3, an anode of the seventh diode D7 is connected to the second end of the third inductor unit L3, and a cathode of the seventh diode D7 is connected to the second end of the first capacitor C1; and the eighth diode D8 and the fifth switch transistor Q5 are connected in series in a circuit between the second end of the second capacitor C2 and the second end of the third inductor unit L3, and an anode of the eighth diode D8 is connected to the second end of the third inductor unit L3.

The fourth control circuit K4 includes a ninth diode D9, a tenth diode D10, and a sixth switch transistor Q6, where the ninth diode D9 is connected in series in a circuit between the second end of the fourth capacitor C4 and a second end of the fourth inductor unit L4, an anode of the ninth diode D9 is connected to the second end of the fourth inductor unit L4, and a cathode of the ninth diode D9 is connected to the second end of the fourth capacitor C4; and the tenth diode D10 and the sixth switch transistor Q6 are connected in series in a circuit between the second end of the third capacitor C3 and the second end of the fourth inductor unit L4, and an anode of the tenth diode D10 is connected to the second end of the fourth inductor unit L4.

The second switching circuit 2 of the five-level power converter in this embodiment is configured to switch the flow of an energy storage current provided by the external input power supply from the first end to the second end of the third inductor unit L3 or from the second end to the first end of the fourth inductor unit L4.

Specifically, the second switching circuit 2 may include a seventh switch transistor Q7, an eighth switch transistor Q8, a thirteenth diode D13, and a fourteenth diode D14, where one end of the seventh switch transistor Q7 is connected to the second end of the third inductor unit L3 and a cathode of the thirteenth diode D13, and the other end of the seventh switch transistor Q7 is grounded; one end of the eighth switch transistor Q8 is connected to the second end of the fourth inductor unit L4 and an anode of the fourteenth diode D14, and the other end of the eighth switch transistor Q8 is grounded; and an anode of the thirteenth diode D13 and a cathode of the fourteenth diode D14 are grounded.

In the five-level power converter in this embodiment, the external input power supply includes an external alternating current input power supply V or a battery group, where the external input power supply and the first end of the third inductor unit L3, as well as the external alternating current input power supply V and the first end of the fourth inductor unit L4, are connected by using an alternating current switch component.

The battery group includes a fifth battery unit V5 and a sixth battery unit V6, where an anode of the fifth battery unit V5 is connected to the first end of the third inductor unit L3 by using a direct current switch component X5, and a cathode of the fifth battery unit V5 is grounded; and a cathode of the sixth battery unit V6 is connected to the first end of the fourth inductor unit L4 by using a direct current switch component X6, and an anode of the sixth battery unit V6 is grounded.

In this embodiment, the five-level rectifier in a power converter architecture in the first embodiment is replaced with a five-level double-Boost circuit, and an alternating current or battery input control relay or a silicon controlled thyristor (SCR) is added, to form the schematic circuit diagram of a five-level power converter according to the fourth embodiment shown in FIG. 4.

Further, in the five-level power converter in each of the above embodiments, the first inductor unit L1, the second inductor L2, the third inductor unit L3, or the fourth inductor unit L4 is formed by: a single inductor component, or multiple inductor components connected in parallel, or multiple inductor components connected in series.

Optionally, the circuit in the five-level power converter according to the second embodiment to the fourth embodiment may use two groups of batteries and a proper switch component may be configured at an input end, so that the five-level rectifier has a direct current boost function to form output positive and negative BUS voltages and positive and negative Vin. Therefore, the power components in rectification mode can be reused in battery mode. In addition, the above circuit may also work with a single battery group. An SCR, a relay, and a power switch transistor may be used as battery input switch components; a triode alternating current semiconductor switch (TRIAC), a relay, and a power switch transistor may be used as alternating current input switch components.

In the five-level power converter in each of the above embodiments, the discharge control circuit includes a ninth switch transistor Q9, a tenth switch transistor Q10, an eleventh switch transistor Q11, a twelfth switch transistor Q12, a thirteenth switch transistor Q13, a fourteenth switch transistor Q14, and a third switching circuit 3.

A first end of the ninth switch transistor Q9 is connected to the second end of the first capacitor C1, a second end of the ninth switch transistor Q9 is connected to a first end of the tenth switch transistor Q10, a second end of the tenth switch transistor Q10 is connected to the second end of the first inductor unit L1, a first end of the eleventh switch transistor Q11 is connected to the second end of the second capacitor C2 and an anode of the eleventh diode D11, and a second end of the eleventh switch transistor Q11 is connected to the first end of the tenth switch transistor Q10 and a cathode of the eleventh diode D11; a first end of the fourteenth switch transistor Q14 is connected to the second end of the fourth capacitor C4, a second end of the fourteenth switch transistor Q14 is connected to a first end of the thirteenth switch transistor Q13, a second end of the thirteenth switch transistor Q13 is connected to the second end of the first inductor unit L1, a first end of the twelfth switch transistor Q12 is connected to the second end of the third capacitor C3 and a cathode of the twelfth diode D12, and a second end of the twelfth switch transistor Q12 is connected to a second end of the fourteenth switch transistor Q14 and an anode of the twelfth diode D12.

A first end of the third switching circuit 3 is connected to the second end of the first inductor unit L1, and a second end of the third switching circuit 3 is grounded, so as to implement forward conduction from the second end to the first end of the third switching circuit 3 or reverse conduction from the first end to the second end of the third switching circuit 3 by time.

Optionally, the inverter in the above discharge control circuit uses a five-level structure, in which four inverter main switch transistors Q9, Q10, Q13, and Q14 are connected to form an I-shape structure; two inverter free-wheeling switch transistors Q11 and Q12 are connected to form a T-shape structure; inverter external transistors Q9 and Q14 are connected to positive and negative BUS voltages; and inverter internal transistors Q10 and Q13 are connected to positive and negative Vin voltages.

In a rectifier control circuit and a discharge control circuit formed by a rectifier and an inverter of the five-level power converter according to each of the above embodiments, the rectifier converts an input alternating current to a direct current and implements a PFC function, and the inverter inverts the direct current voltage after rectification to an alternating current output voltage, thereby implementing a circuit outputting five levels.

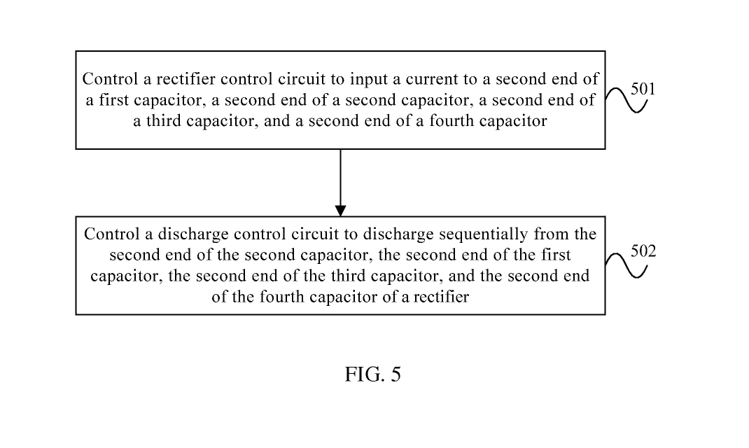

FIG. 5 is a flowchart of a control method for a five-level power converter according to a first embodiment of the present invention. As shown in FIG. 5 and with reference to FIG. 1 to FIG. 4, the embodiment of a control method for a five-level power converter corresponds to the first embodiment of a five-level power converter and illustrates a control method for the five-level power converter provided in each of the above embodiments. The control method for the five-level power converter includes the following:

Step 501: Control a rectifier control circuit to input a current to a second end of a first capacitor C1, a second end of a second capacitor C2, a second end of a third capacitor C3, and a second end of a fourth capacitor C4, where polarities of charges accumulated at the second end of the first capacitor C1 and the second end of the second capacitor C2 are the same, and the amount of electricity accumulated at the second end of the first capacitor C1 is greater than the amount of electricity accumulated at the second end of the second capacitor C2; polarities of charges accumulated at the second end of the third capacitor C3 and the second end of the fourth capacitor C4 are the same, and the amount of electricity accumulated at the second end of the fourth capacitor C4 is greater than the amount of electricity accumulated at the second end of the third capacitor C3; a polarity of charges accumulated at the second ends of the first capacitor C1 and the second capacitor C2 is opposite to a polarity of charges accumulated at the second ends of the third capacitor C3 and the fourth capacitor C4.

Step 502: Control a discharge control circuit to discharge sequentially from the second end of the second capacitor C2, the second end of the first capacitor C1, the second end of the third capacitor C3, and the second end of the fourth capacitor C4 of a rectifier, where a discharge current flows through a first inductor unit L1 and a first load R1 connected in series, and the charging and discharging of any of the first capacitor C1, the second capacitor C2, the third capacitor C3, and the fourth capacitor C4 are staggered.

According to a control method for a five-level power converter provided in an embodiment of the present invention, the rectifier control circuit is controlled to input a current to the first capacitor C1 to the fourth capacitor C4 to store energy in the capacitors, and the discharge control circuit is controlled to discharge sequentially from the first capacitor C1 to the fourth capacitor C4 of the rectifier to release energy stored in the capacitors, thereby implementing five-level output for a UPS system and implementing input of a PFC function.

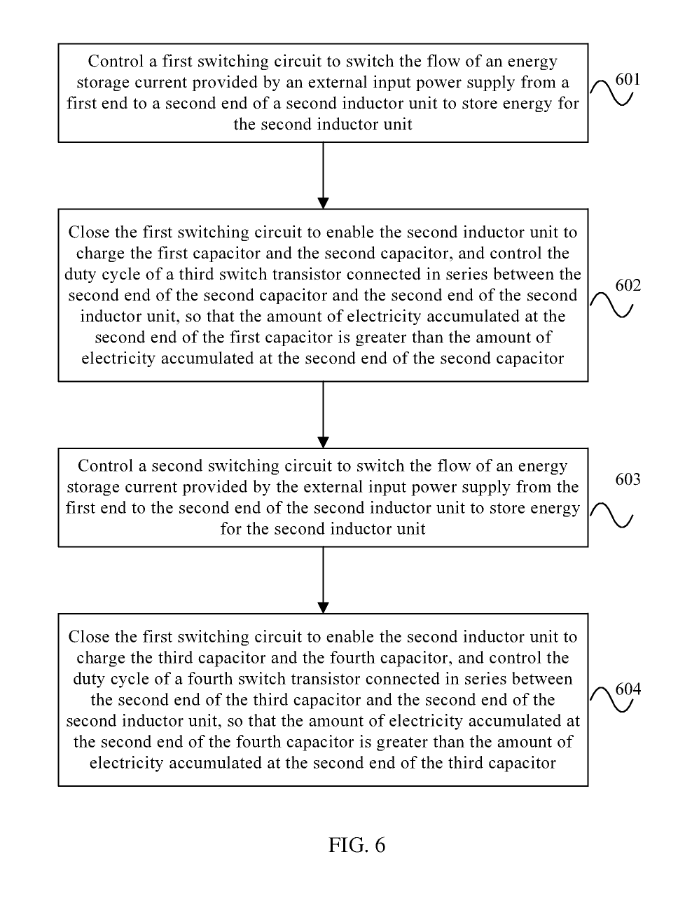

FIG. 6 is a flowchart of a control method for a five-level power converter according to a second embodiment of the present invention. As shown in FIG. 6 and with reference to FIG. 1, optionally, in step 501 of the first method embodiment, the controlling a rectifier control circuit to input a current to a second end of a first capacitor C1, a second end of a second capacitor C2, a second end of a third capacitor C3, and a second end of a fourth capacitor C4 includes:

Step 601: Control a first switching circuit 1 to switch the flow of an energy storage current provided by an external input power supply from a first end to a second end of a second inductor unit L2 to store energy for the second inductor unit L2.

Step 602: Turn off the first switching circuit 1 to enable the second inductor unit L2 to charge the first capacitor C1 and the second capacitor C2, and control the duty cycle of a third switch transistor Q3 connected in series between the second end of the second capacitor C2 and the second end of the second inductor unit L2, so that the amount of electricity accumulated at the second end of the first capacitor C1 is greater than the amount of electricity accumulated at the second end of the second capacitor C2.

Step 603: Control the first switching circuit 1 to switch the flow of an energy storage current provided by the external input power supply from the second end to the first end of the second inductor unit L2 to store energy for the second inductor unit L2.

Step 604: Turn off the first switching circuit 1 to enable the second inductor unit L2 to charge the third capacitor C3 and the fourth capacitor C4, and control the duty cycle of a fourth switch transistor Q4 connected in series between the second end of the third capacitor C3 and the second end of the second inductor unit L2, so that the amount of electricity accumulated at the second end of the fourth capacitor C4 is greater than the amount of electricity accumulated at the second end of the third capacitor C3.

The following briefly describes the working principle of the five-level rectifier in the first and second method embodiments by using a positive half cycle of an input voltage sine wave as an example:

When a first switch transistor Q1 is conducted, a current flows through an input voltage line and the second inductor unit L2, the first switch transistor Q1, and a second diode D2, and then returns to an output line, and the second inductor unit of PFC stores energy. When the first switch transistor Q1 is turned off, the second inductor unit L2 releases energy by using two approaches: one is that the second inductor unit L2 charges the first capacitor C1 by using a third diode D3, forming positive BUS voltage at both ends of the first capacitor C1; the other one is that the second inductor unit L2 charges the second capacitor C2 by conducting the third switch transistor Q3 in on/off state, forming positive Vin voltage at both ends of the second capacitor C2. Changing the duty cycle of the third switch transistor Q3 may control the amount of electricity to be charged to the second capacitor C2, so that the voltage at both ends of the second capacitor C2 reaches a set value of a positive Vin voltage. The third switch transistor Q3 can be conducted only when the second inductor unit L2 releases energy, so as to maintain normal operating. In essence, the third diode D3 and the first capacitor C1 constitute a boost Boost converter, and positive BUS voltage output is implemented at both ends of the first capacitor C1; a fourth diode D4, the third switch transistor Q3, and the second capacitor C2 constitute a buck Buck converter, and positive Vin voltage output is implemented at both ends of the second capacitor C2.

The working principle in a negative half cycle of an input voltage sine wave of the five-level rectifier is similar. In the negative half cycle, when the second switch transistor Q2 and the first diode D1 are conducted, the input current is opposite to that in the positive half cycle, that is, a current flowing through the second inductor unit L2 is opposite; the charging of the third capacitor C3 and the fourth capacitor C4 is turned off after energy storing. The details are not repeated herein.

In this embodiment, by switching of the first switching circuit 1, energy may be stored for the first capacitor C1 and the second capacitor C2 or for the third capacitor C3 and the fourth capacitor C4, and a zero level is formed at an intermediate point of an energy storage circuit, that is, a point between the first capacitor C1 and the fourth capacitor C4. Therefore, a five-level rectifier circuit may implement positive and negative BUS voltages, positive and negative Vin voltages, and the zero level.

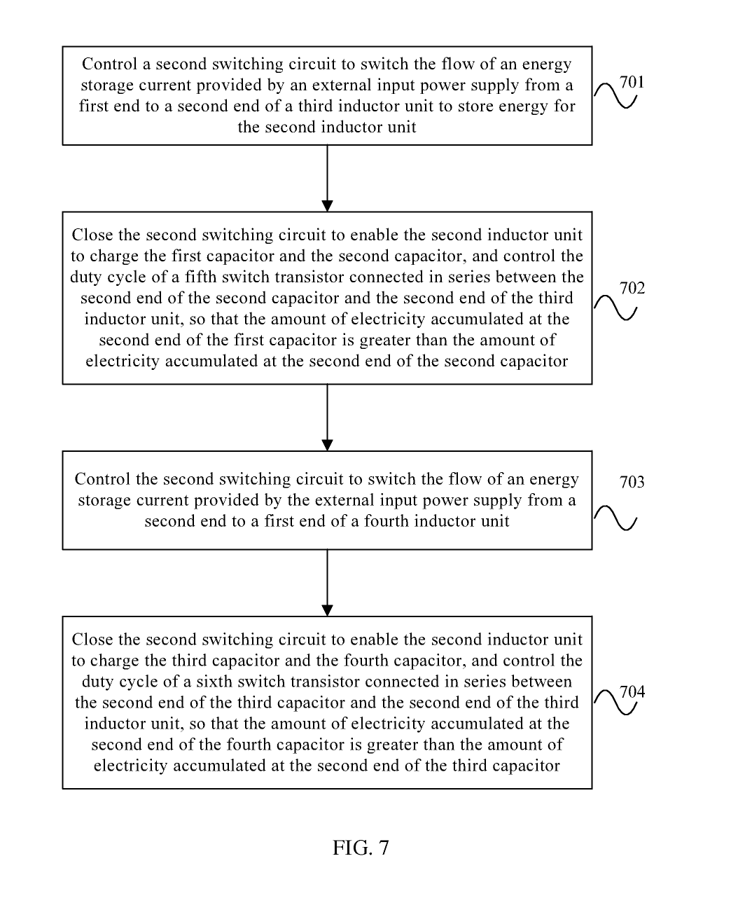

FIG. 7 is a flowchart of a control method for a five-level power converter according to a third embodiment of the present invention. The third embodiment of the method for the five-level power converter corresponds to the fourth embodiment of the five-level power converter. As shown in FIG. 7 and with reference to FIG. 4, or the first method embodiment, the controlling a rectifier control circuit to input a current to a second end of a first capacitor C1, a second end of a second capacitor C2, a second end of a third capacitor C3, and a second end of a fourth capacitor C4 in step 501 includes the following:

Step 701: Control a second switching circuit 2 to switch the flow of an energy storage current provided by an external input power supply from a first end to a second end of a third inductor unit L3 to store energy for the third inductor unit L3.

Step 702: Turn off the second switching circuit 2 to enable the second inductor unit L2 to charge the first capacitor C1 and the second capacitor C2, and control the duty cycle of a fifth switch transistor Q5 connected in series between the second end of the second capacitor C2 and the second end of the second inductor unit L3, so that the amount of electricity accumulated at the second end of the first capacitor C1 is greater than the amount of electricity accumulated at the second end of the second capacitor C2.

Step 703: Control the second switching circuit 2 to switch the flow of an energy storage current provided by the external input power supply from a second end to a first end of a fourth inductor unit L4.

Step 704: Turn off the second switching circuit 2 to enable the second inductor unit L2 to charge the third capacitor C3 and the fourth capacitor C4, and control the duty cycle of a sixth switch transistor Q6 connected in series between the second end of the third capacitor C3 and the second end of the third inductor unit L3, so that the amount of electricity accumulated at the second end of the fourth capacitor C4 is greater than the amount of electricity accumulated at the second end of the third capacitor C3.

The working principle of a circuit according to the third embodiment of the control method for the five-level power converter is similar to that in the above method embodiment, except that two sets of Boost circuits are used to form dual Boost circuits to output positive and negative BUS voltages. Meanwhile, two tributaries, that is, the fifth switch transistor Q5 and the eighth diode D8, as well as the sixth switch transistor Q6 and the tenth diode D10, form tributary positive and negative Vin voltages. A direct current switch component X5 and a direct current switch component X6 of a control relay or an SCR form a switching switch in battery mode; an alternating current switch component X7 and an alternating current switch component X8 form a switching switch in alternating current power supply mode, which are used to switch the energy storage for the first capacitor C1 and the second capacitor C2 or for the third capacitor C3 and the fourth capacitor C4, to adapt to the application of a UPS system. Optionally, the system may operate properly even with a single battery group.

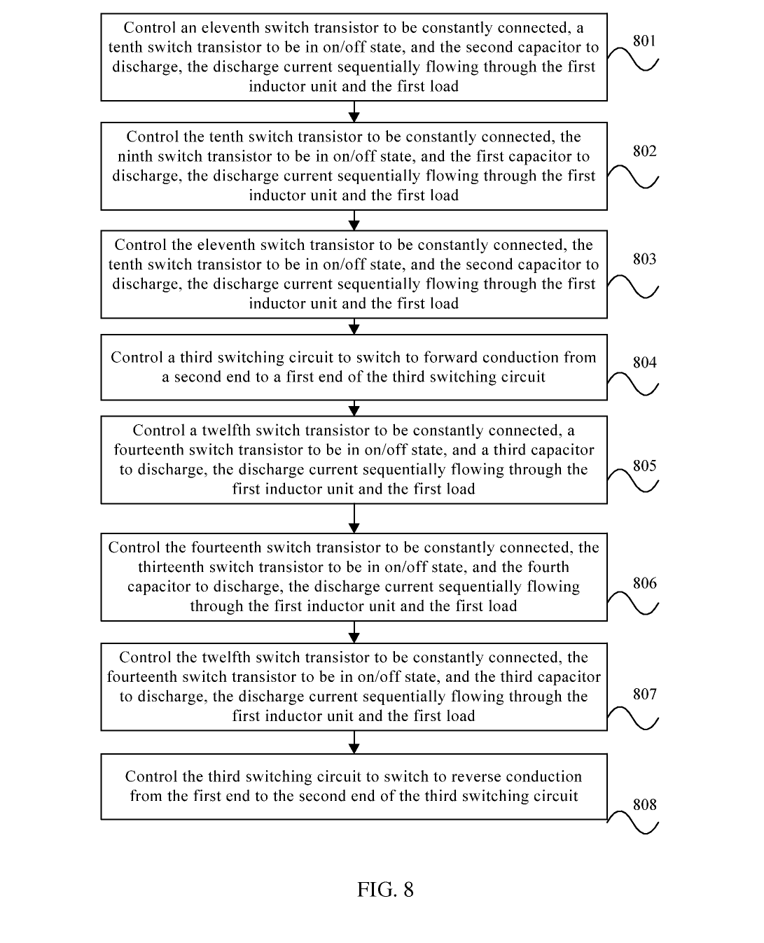

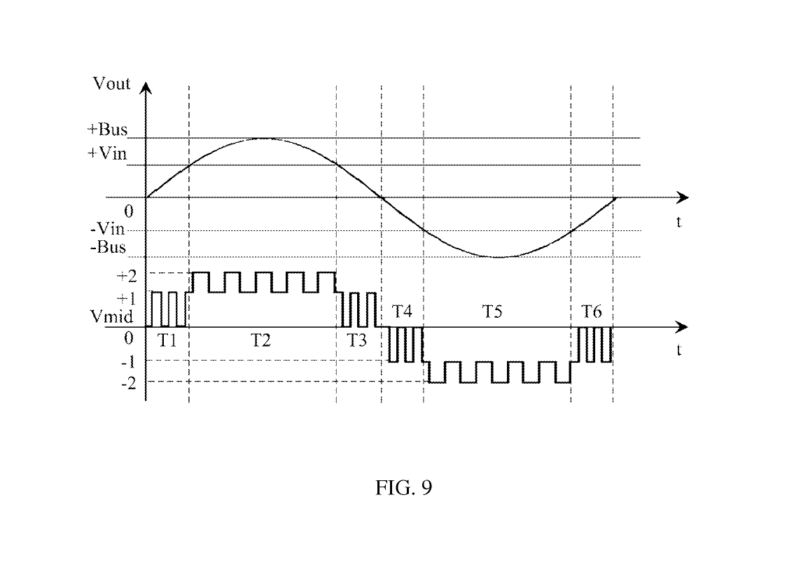

FIG. 8 is a flowchart of a control method for a five-level power converter according to a fourth embodiment of the present invention. FIG. 9 is a schematic diagram of a working voltage waveform for a control method for a five-level power converter according to the fourth embodiment of the present invention, and T1 to T6 represent time periods in FIG. 9. The fourth embodiment of the control method for the five-level power converter corresponds to embodiments of the five-level power converter shown in FIG. 1 to FIG. 4. As shown in FIG. 8 and FIG. 9 and with reference to FIG. 1 to FIG. 4, the embodiment of the control method for the five-level power converter further includes the following:

Step 801: In a time period T1, control an eleventh switch transistor Q11 to be constantly conducted, control a tenth switch transistor Q10 to be in on/off state, control a ninth switch transistor Q9 to be in turn-off state, and control the second capacitor C2 to discharge, where a discharge current sequentially flows through the first inductor unit L1 and the first load R1.

Step 802: In a time period T2, control the tenth switch transistor Q10 to be constantly conducted, control the ninth switch transistor Q9 to be in on/off state, t control the eleventh switch transistor Q11 to be constantly conducted, and control the first capacitor C1 to discharge, where a discharge current sequentially flows through the first inductor unit L1 and the first load R1.

Step 803: In a time period T3, control the eleventh switch transistor Q11 to be constantly conducted, control the tenth switch transistor Q10 to be in on/off state, control the ninth switch transistor Q9 to be in turn-off state, and control the second capacitor C2 to discharge, where a discharge current sequentially flows through the first inductor unit L1 and the first load R1.

Step 804: Control a third switching circuit 3 to switch to forward conduction from a second end to a first end of the third switching circuit 3.

Step 805: In a time period T4, control a twelfth switch transistor Q12 to be constantly conducted, control a thirteenth switch transistor Q13 to be in on/off state, control a fourteenth switch transistor Q14 to be in turn-off state, and control the third capacitor C3 to discharge, where a discharge current sequentially flows through the first inductor unit L1 and the first load R1.

Step 806: In a time period T5, control the thirteenth switch transistor Q13 to be constantly conducted, control the fourteenth switch transistor Q14 to be in on/off state, control the twelfth switch transistor Q12 to be constantly conducted, and control the fourth capacitor C4 to discharge, where a discharge current sequentially flows through the first inductor unit L1 and the first load R1.

Step 807: In a time period T6, control the twelfth switch transistor Q12 to be constantly conducted, control the thirteenth switch transistor Q13 to be in on/off state, control the fourteenth switch transistor Q14 to be in turn-off state, and control the third capacitor C3 to discharge, where a discharge current sequentially flows through the first inductor unit L1 and the first load R1.

Step 808: Control the third switching circuit 3 to switch to reverse conduction from the first end to the second end of the third switching circuit 3.

As shown in FIG. 9, in this embodiment, two different kinds of voltages, that is, positive and negative BUS voltages and positive and negative Vin voltages (Boost output voltages +BUS and −BUS and Buck output voltages +Vin and −Vin), and a zero level are formed, which may implement five levels for an inverter neutral-point voltage. As shown in FIG. 9, a horizontal axis represents time t, a vertical axis in the upper diagram represents a waveform of an output voltage Vout at both ends of the first load R1 in the above embodiment, and a vertical axis in the lower diagram represents a waveform of an output voltage Vmid between inverter points A and B. The sine waveform of the output voltage Vout denotes the voltage between two ends of either the fifth capacitor C5 or the first load R1, and the sine waveform is formed as follows: the waveform Vmid between points A and B are filtered by the first inductor unit L1 and the fifth capacitor C5, and then the sine waveform is output after the high-frequency square waveform is filtered.

With reference to FIG. 9, the following describes the working principle of the five-level inverter in the embodiment by using the positive half cycle of an input voltage sine wave as an example:

The voltage of an output voltage neutral point involves two cases, that is, an output sine wave voltage waveform is divided into two segments: the output voltage Vout is smaller than the voltage at both ends of the second capacitor C2, and the output voltage Vout is greater than the voltage at both ends of the second capacitor C2. Therefore, two working modes exist. In working mode 1, in time periods T1 and T3, corresponding to steps 801 and 803, the output voltage Vout is smaller than the voltage at both ends of the second capacitor C2. In this case, the eleventh switch transistor Q11 is constantly conducted, the tenth switch transistor Q10 works in on/off state, and the fifteenth switch transistor Q15 and the fifteenth diode D15 form a free-wheeling path, to obtain a +Vin voltage and a zero level of the output voltage between inverter neutral points A and B. In working mode 2, in a time period T2, corresponding to step 802, the output voltage Vout is greater than the voltage at both ends of the second capacitor C2. In this case, the tenth switch transistor Q10 is constantly conducted, the ninth switch transistor Q9 works in on/off state, and the tenth switch transistor Q10 and the eleventh diode D11 form a free-wheeling path, to obtain +Vin and +BUS voltages of the output voltage between inverter neutral points A and B. In the above free-wheeling path, at a vertical bridge arm, that is, when the ninth switch transistor Q9 and the tenth switch transistor Q10 are in turn-off state, a free-wheeling path may be provided for the first inductor unit L11, to implement a zero level for an output inverter neutral point.

Specifically, in the positive half cycle, the procedures for obtaining voltages +BUS and +Vin are as follows: in a time period T2, when the ninth switch transistor Q9 and the tenth switch transistor Q10 in step 802 are conducted, energy from the first capacitor C1 in the Boost circuit is transmitted to the first inductor unit L1 and output. The +BUS voltage between points A and B may also called +2 level. In time periods T1 and T3, when the ninth switch transistor Q9 in steps 801 and 803 is turned off, the eleventh diode D11 and the tenth switch transistor Q10 are conducted, and energy from the second capacitor C2 is transmitted to the first inductor unit L1 and output. The +Vin voltage between points A and B may also be called +1 level. When the above free-wheeling path works, the ninth switch transistor Q9 and the tenth switch transistor Q10 in steps 801 and 803 are turned off while the fifteenth switch transistor Q15 and the fifteenth diode D15 are conducted, a zero level between points A and B is obtained at the first inductor unit L1 and output.

Therefore, three levels may be obtained at output voltage neutral points: +Vin, +BUS, and a zero level.

Similarly, in the negative half cycle of an output voltage sine wave of a five-level inverter, −Vin and −BUS may be obtained, which correspond to −1 level and −2 level, and a time period T4 and time periods T6 and T5. Details are not repeated herein.

In this embodiment, because a direct current input voltage is low, the switching loss of an internal transistor of the switch transistor can be reduced in construction of a lower half segment of a sine wave. Meanwhile, a BOOST circuit processes only partial power and the conduction loss is small. Implementing multiple levels may reduce the switching loss. Because an inverter neutral-point voltage is five levels, output inverter induction can be reduced, an output current harmonic can be improved, and an output voltage harmonic distortion THDv can be improved. Additionally, like a common three-level inverter, fast recovery diodes are used as the fifteenth diode D15 and the sixteenth diode D16. To further improve efficiency, MOSFETs/IGBTs may be connected in parallel, and the switch transistor components connected in parallel may also provide a reactive compensation current path. Meanwhile, proper control logic is used. When the inverter limits an output current, the fifteenth switch transistor Q15 and the fifteenth diode D15, or the sixteenth switch transistor Q16 and the sixteenth diode D16 are conducted to provide an output current free-wheeling path, which may reduce the voltage stress of switch transistors. Additionally, power transistors and switch transistors are placed in a centralized manner, facilitating the increase of component utilization and facilitating integration in a single power module to reduce power consumption.

With the control method for a five-level power converter provided in each of the above embodiments, a circuit formed by a rectifier and an inverter can be controlled to implement five-level operations, which may be applied to a UPS system. When an alternating current power supply is interrupted, the UPS immediately uses electric energy stored in an internal energy storage apparatus to continuously supply an alternating current power to a load by using an inverse transform approach, so that the load keeps working properly.

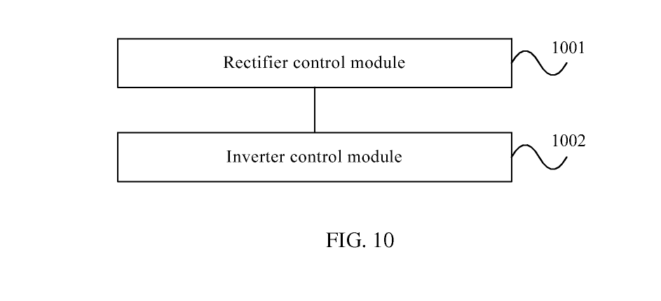

Corresponding to the above control method embodiments, the present invention further provides a control apparatus for controlling a five-level power converter shown in FIG. 1 to FIG. 4. FIG. 10 is a structural schematic diagram of a control apparatus for a five-level power converter according to a first embodiment of the present invention. As shown in FIG. 10 and with reference to FIG. 1 to FIG. 4, the apparatus embodiment is specific to the apparatus for controlling the five-level power converter. The apparatus includes: a rectifier control module 1001 configured to control a rectifier control circuit to input a current to a second end of a first capacitor C1, a second end of a second capacitor C2, a second end of a third capacitor C3, and a second end of a fourth capacitor C4, where polarities of charges accumulated at the second end of the first capacitor C1 and the second end of the second capacitor C2 are the same, and the amount of electricity accumulated at the second end of the first capacitor C1 is greater than the amount of electricity accumulated at the second end of the second capacitor C2; polarities of charges accumulated at the second end of the third capacitor C3 and the second end of the fourth capacitor C4 are the same, and the amount of electricity accumulated at the second end of the fourth capacitor C4 is greater than the amount of electricity accumulated at the second end of the third capacitor C3; a polarity of charges accumulated at the second ends of the first capacitor C1 and the second capacitor C2 is opposite to a polarity of charges accumulated at the second ends of the third capacitor C3 and the fourth capacitor C4; and an inverter control module 1002 configured to control a discharge control circuit to discharge sequentially from the second end of the second capacitor C2, the second end of the first capacitor C1, the second end of the third capacitor C3, and the second end of the fourth capacitor C4 of the rectifier, where a discharge current flows through a first inductor unit L1 and a first load R1 connected in series, and the charging and discharging of any of the first capacitor C1, the second capacitor C2, the third capacitor C3, and the fourth capacitor C4 are staggered.

The control apparatus for a five-level power converter provided in a first embodiment of the present invention, energy storing and electricity discharging of the first capacitor C1 and the second capacitor C2 or energy storing and electricity discharging of the third capacitor C3 and the fourth capacitor C4 are implemented by using a rectifier control module 1001 and an inverter control module 1002, thereby implementing five-level output and an input PFC function.

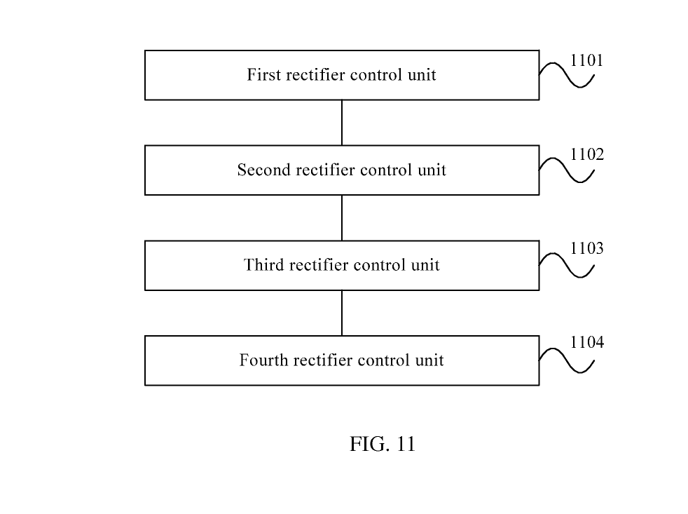

In the control apparatus for a five-level power converter provided in the embodiment of the present invention, the rectifier control module may have multiple composition forms. For example, it may use a form shown in FIG. 11. FIG. 11 is a structural schematic diagram of a control apparatus for a five-level power converter according to a second embodiment of the present invention. The rectifier control module in the second embodiment corresponds to the rectifier control circuit shown in FIG. 1. As shown in FIG. 11 and with reference to FIG. 1, the rectifier control module includes: a first rectifier control unit 1101 configured to control a first switching circuit 1 to switch the flow of an energy storage current provided by an external input power supply from a first end to a second end of a second inductor unit L2 to store energy for the second inductor unit L2; a second rectifier control unit 1102 configured to turn off the first switching circuit 1 to enable the second inductor unit L2 to charge a first capacitor C1 and a second capacitor C2, and control the duty cycle of a third switch transistor Q3 connected in series between a second end of the second capacitor C2 and a second end of the second inductor unit L2, so that the amount of electricity accumulated at the second end of the first capacitor C1 is greater than the amount of electricity accumulated at the second end of the second capacitor C2; a third rectifier control unit 1103 configured to control the first switching circuit 1 to switch the flow of the energy storage current provided by the external input power supply from a second end to a first end of the second inductor unit L2 to store energy for the second inductor unit L2; and a fourth rectifier control unit 1104 configured to turn off the first switching circuit 1 to enable the second inductor unit L2 to charge a third capacitor C3 and a fourth capacitor C4, and control the duty cycle of a fourth switch transistor Q4 connected in series between a second end of the third capacitor C3 and a second end of the second inductor unit L2, so that the amount of electricity accumulated at the second end of the fourth capacitor C4 is greater than the amount of electricity accumulated at the second end of the third capacitor C3.

In this embodiment, by switching of the first switching circuit 1, the flow of an energy storage current provided by the external input power supply is switched from the first end to the second end of the second inductor unit L2 or from the second end to the first end of the second inductor unit L2 to implement energy storage for the second inductor unit L2, and then the first switching circuit 1 is turned off to implement charging for the first capacitor C1 and the second capacitor C2 or for the third capacitor C3 and the fourth capacitor C4.

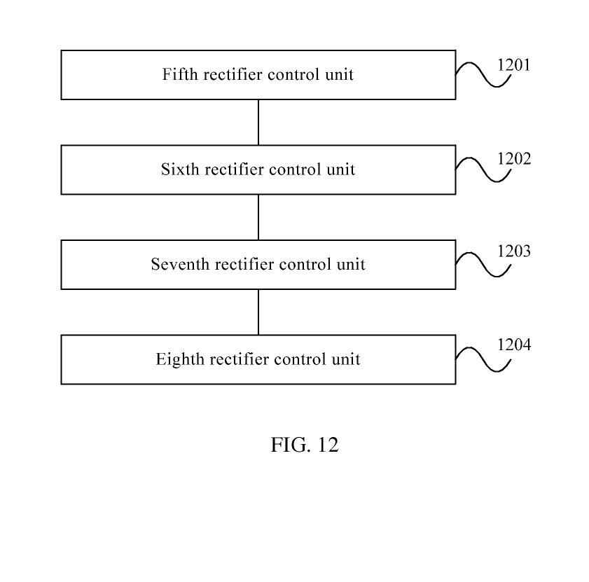

FIG. 12 is a structural schematic diagram of a control apparatus for a five-level power converter according to a third embodiment of the present invention. The rectifier control module in the third embodiment corresponds to the rectifier control circuit shown in FIG. 4. As shown in FIG. 12 and with reference to FIG. 4, the rectifier control module includes: a fifth rectifier control unit 1201 configured to control a second switching circuit 2 to switch the flow of an energy storage current provided by an external input power supply from a first end to a second end of a third inductor unit L3 to store energy for the third inductor unit L3; a sixth rectifier control unit 1202 configured to turn off the second switching circuit 2 to enable a second inductor unit L2 to charge a first capacitor C1 and a second capacitor C2, and control the duty cycle of a fifth switch transistor Q5 connected in series between a second end of the second capacitor C2 and a second end of the third inductor unit L3, so that the amount of electricity accumulated at the second end of the first capacitor C1 is greater than the amount of electricity accumulated at the second end of the second capacitor C2; a seventh rectifier control unit 1203 configured to control the second switching circuit 2 to switch the flow of the energy storage current provided by the external input power supply from a second end to a first end of a fourth inductor unit L4; and an eighth rectifier control unit 1204 configured to turn off the second switching circuit 2 to enable the second inductor unit L2 to charge a third capacitor C3 and a fourth capacitor C4, and control the duty cycle of a sixth switch transistor Q6 connected in series between a second end of the third capacitor C3 and a second end of the third inductor unit L3, so that the amount of electricity accumulated at the second end of the fourth capacitor C4 is greater than the amount of electricity accumulated at the second end of the third capacitor C3.

In this embodiment, by switching of the second switching circuit 2, the flow of the energy storage current provided by the external input power supply is switched from the first end to the second end of the third inductor unit L3 to implement energy storage for the third inductor unit L3, or from the second end to the first end of the fourth inductor unit L4 to implement energy storage for the fourth inductor unit L4, and then, the second switching circuit 2 is turned off to implement charging for the first capacitor C1 and the second capacitor C2 or for the third capacitor C3 and the fourth capacitor C4.

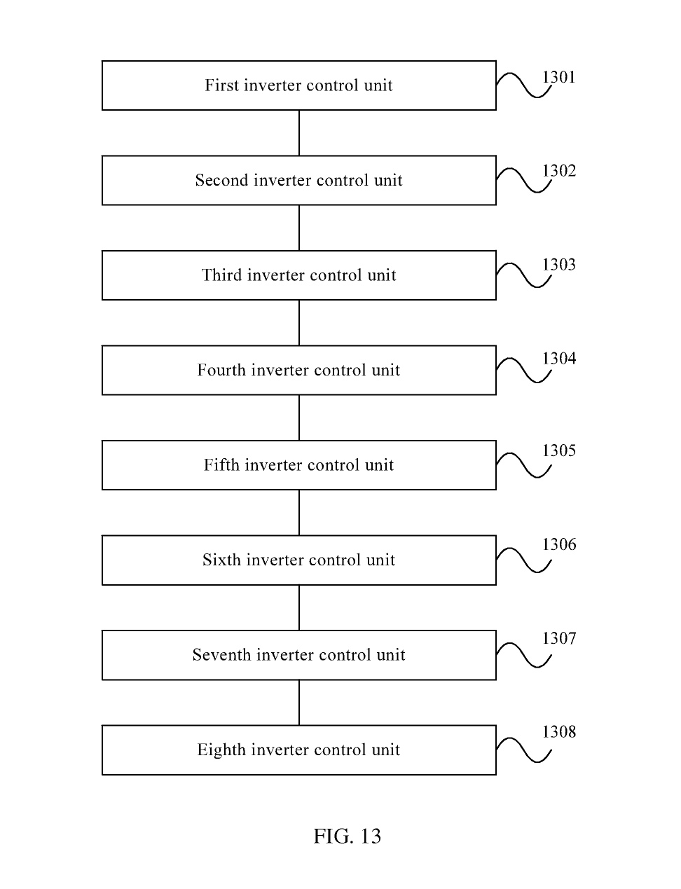

FIG. 13 is a structural schematic diagram of a control apparatus for a five-level power converter according to a fourth embodiment of the present invention. The inverter control module in the fourth embodiment corresponds to the inverter control circuit shown in FIG. 1 to FIG. 4, and each unit in the following outputs a voltage in each time period shown in FIG. 9. As shown in FIG. 9 and FIG. 13 and with reference to FIG. 1 to FIG. 4, the inverter control module in each of the above apparatus embodiments includes: a first inverter control unit 1301, with an output voltage corresponding to a time period T1 configured to control an eleventh switch transistor Q11 to be constantly conducted, a tenth switch transistor Q10 to be in on/off state, a ninth switch transistor Q9 to be in turn-off state, and a second capacitor C2 to discharge, where a discharge current sequentially flows through a first inductor unit L1 and a first load R1; a second inverter control unit 1302, with an output voltage corresponding to a time period T2 configured to control the tenth switch transistor Q10 to be constantly conducted, the ninth switch transistor Q9 to be in on/off state, the eleventh switch transistor Q11 to be constantly conducted, and a first capacitor C1 to discharge, where a discharge current sequentially flows through the first inductor unit L1 and the first load R1; a third inverter control unit 1303, with an output voltage corresponding to a time period T3 configured to control the eleventh switch transistor Q11 to be constantly conducted, the tenth switch transistor Q10 to be in on/off state, the ninth switch transistor Q9 to be in turn-off state, and the second capacitor C2 to discharge, where a discharge current sequentially flows through the first inductor unit L1 and the first load R1; a fourth inverter control unit 1304 configured to control a third switching circuit to switch to forward conduction from a second end to a first end of the third switching circuit 3; a fifth inverter control unit 1305, with an output voltage corresponding to a time period T4 configured to control a twelfth switch transistor Q12 to be constantly conducted, a thirteenth switch transistor Q13 to be in on/off state, a fourteenth switch transistor Q14 to be in turn-off state, and a third capacitor C3 to discharge, where a discharge current sequentially flows through the first inductor unit L1 and the first load R1; a sixth inverter control unit 1306, with an output voltage corresponding to a time period T5 configured to control the thirteenth switch transistor Q13 to be constantly conducted, the fourteenth switch transistor Q14 to be in on/off state, the twelfth switch transistor Q12 to be constantly conducted, and a fourth capacitor C4 to discharge, where a discharge current sequentially flows through the first inductor unit L1 and the first load R1; a seventh inverter control unit 1307, with an output voltage corresponding to a time period T6 configured to control the twelfth switch transistor Q12 to be constantly conducted, the thirteenth switch transistor Q13 to be in on/off state, the fourteenth switch transistor Q14 to be in turn-off state, and the third capacitor C3 to discharge, where a discharge current sequentially flows through the first inductor unit L1 and the first load R1; and an eighth inverter control unit 1308 configured to control a third switching circuit 3 to switch to reverse conduction from a first end to a second end of the third switching circuit 3.

In the control apparatus for a five-level power converter in each of the above embodiments, a circuit is formed by a rectifier control module and an inverter control module. The rectifier control module controls the circuit to convert an input alternating current to a direct current and implement a power factor corrector PFC function; the inverter control module controls the circuit to invert the direct current voltage after rectification to an alternating current output voltage, thereby implementing a circuit outputting five levels.

The controller of the circuit provided in the above apparatus embodiment may be implemented using a digital signal processing chip such as a micro control unit (MCU), a digital signal processor (DSP), or a complex programmable logic device (CPLD).

To sum up, with the technical solutions provided in embodiments of the present invention, the rectifier and inverter can work in five levels by adding a tributary based on a power converter. Specifically, the five-level inverter and rectifier are cascaded to form a high-performance online UPS system. This UPS has the advantages of the five-level inverter and rectifier, such as low power transistor conductivity loss, low switching loss, small inversion or rectification inductance, and better input and output total harmonic distortion (THD). The circuit topology in embodiments of the present invention may flexibly form a single-phase UPS, a three-phase UPS, and a three-phase system with or without a neutral line. It can implement interleaved parallel in alternating current mains mode, as well as easily implementing interleaved parallel in battery mode by using an input switch. Additionally, the overall circuit has a simple structure and runs reliably.

Finally, it should be noted that the foregoing embodiments are merely intended for describing the technical solutions of the present invention other than limiting the present invention. Although the present invention is described in detail with reference to the foregoing embodiments, a person of ordinary skill in the art should understand that modifications may still be made to the technical solutions described in the foregoing embodiments, or equivalent replacements may be made to some or all the technical features thereof, without departing from the idea and scope of the technical solutions of the embodiments of the present invention.

What is claimed is:

1. A five-level power converter, comprising:
an inverter; and
at least one rectifier,
wherein the rectifier comprises a rectifier control circuit, a first capacitor, and a second capacitor connected in parallel, and a third capacitor and a fourth capacitor connected in parallel, wherein a first end of the first capacitor, a first end of the second capacitor, a first end of the third capacitor, and a first end of the fourth capacitor are grounded,
wherein the rectifier control circuit is configured to input a current to a second end of the first capacitor, a second end of the second capacitor, a second end of the third capacitor, and a second end of the fourth capacitor, wherein polarities of charges accumulated at the second end of the first capacitor and the second end of the second capacitor are the same, and the amount of electricity accumulated at the second end of the first capacitor is greater than the amount of electricity accumulated at the second end of the second capacitor, wherein polarities of charges accumulated at the second end of the third capacitor and the second end of the fourth capacitor are the same, and the amount of electricity accumulated at the second end of the fourth capacitor is greater than the amount of electricity accumulated at the second end of the third capacitor, wherein a polarity of charges accumulated at the second ends of the first capacitor and the second capacitor is opposite to a polarity of charges accumulated at the second ends of the third capacitor and the fourth capacitor, and
wherein the inverter comprises a discharge control circuit, and a first inductor unit and a first load connected in series, wherein a first end of the first inductor unit is connected to a first end of the first load, and a second end of the first load is grounded, wherein the discharge control circuit is configured to discharge sequentially from the second end of the second capacitor, the second end of the first capacitor, the second end of the third capacitor, and the second end of the fourth capacitor of the rectifier, wherein a discharge current flows through the first inductor unit and the first load connected in series, and charging and discharging of any of the first capacitor, second capacitor, third capacitor, and fourth capacitor are staggered.

2. The five-level power converter according to claim 1, wherein the rectifier control circuit comprises a second inductor unit, a first switching circuit, a first control circuit, and a second control circuit, wherein a first end of the second inductor unit is connected to an external input power supply, wherein the first control circuit comprises a third diode, a fourth diode, and a third switch transistor, wherein the third diode is connected in series in a circuit between the second end of the first capacitor and a second end of the second inductor unit, an anode of the third diode is connected to the second end of the second inductor unit, and a cathode of the third diode is connected to the second end of the first capacitor, wherein the fourth diode and the third switch transistor are connected in series in a circuit between the second end of the second capacitor and the second end of the second inductor unit, and an anode of the fourth diode is connected to the second end of the second inductor unit, wherein the second control circuit comprises a fifth diode, a sixth diode, and a fourth switch transistor, wherein the fifth diode is connected in series in a circuit between the second end of the fourth capacitor and the second end of the second inductor unit, an anode of the fifth diode is connected to the second end of the second inductor unit, and a cathode of the fifth diode is connected to the second end of the fourth capacitor, wherein the sixth diode and the fourth switch transistor are connected in series in a circuit between the second end of the third capacitor and the second end of the second inductor unit, and an anode of the sixth diode is connected to the second end of the second inductor unit, and wherein the first switching circuit is configured to switch flow of an energy storage current provided by the external input power supply from the first end to the second end of the second inductor unit or from the second end to the first end of the second inductor unit.

3. The five-level power converter according to claim 2, wherein the first switching circuit comprises a first switch transistor and a second switch transistor connected in series, and a first diode and a second diode connected in series, wherein polarities of the first diode and the second diode are set oppositely, and a point between the first switch transistor and the second switch transistor are in communication with a point between the first diode and the second diode.

4. The five-level power converter according to claim 2, wherein the external input power supply comprises an external alternating current input power supply and a battery group, wherein the external alternating current input power supply is connected to the first end of the second inductor unit by using an alternating current switch component, wherein when the rectifier comprises a rectifier control circuit, the battery group comprises a first battery unit and a second battery unit, wherein an anode of the first battery unit is connected to a first end of a second inductor unit in the rectifier control circuit by using a direct current switch component, and a cathode of the first battery unit is grounded, wherein a cathode of the second battery unit is connected to the first end of the second inductor unit in the rectifier control circuit by using a direct current switch component, and an anode of the second battery unit is grounded, or when a first rectifier and a second rectifier are comprised, the battery group comprises a third battery unit and a fourth battery unit, wherein an anode of the third battery unit is connected to a first end of a second inductor unit of the first rectifier by using a direct current switch component, and a cathode of the third battery unit is grounded, and wherein a cathode of the fourth battery unit is connected to the first end of the second inductor unit of the second rectifier by using a direct current switch component, and an anode of the fourth battery unit is grounded.

5. The five-level power converter according to claim 1, wherein the rectifier control circuit comprises a third inductor unit, a fourth inductor unit, a second switching circuit, a third control circuit, and a fourth control circuit, wherein a first end of the third inductor unit and a first end of the fourth inductor unit are connected to an external input power supply, wherein the third control circuit comprises a seventh diode, an eighth diode, and a fifth switch transistor, wherein the seventh diode is connected in series in a circuit between the second end of the first capacitor and a second end of the third inductor unit, an anode of the seventh diode is connected to the second end of the third inductor unit, and a cathode of the seventh diode is connected to the second end of the first capacitor, wherein the eighth diode and the fifth switch transistor are connected in series in a circuit between the second end of the second capacitor and the second end of the third inductor unit, and an anode of the eighth diode is connected to the second end of the third inductor unit, wherein the fourth control circuit comprises a ninth diode, a tenth diode, and a sixth switch transistor, wherein the ninth diode is connected in series in a circuit between the second end of the fourth capacitor and a second end of the fourth inductor unit, an anode of the ninth diode is connected to the second end of the fourth inductor unit, and a cathode of the ninth diode is connected to the second end of the fourth capacitor, wherein the tenth diode and the sixth switch transistor are connected in series in a circuit between the second end of the third capacitor and the second end of the fourth inductor unit, and an anode of the tenth diode is connected to the second end of the fourth inductor unit, and wherein the second switching circuit is configured to switch flow of an energy storage current provided by the external input power supply from the first end to the second end of the third inductor unit or from the second end to the first end of the fourth inductor unit.

6. The five-level power converter according to claim 5, wherein the second switching circuit comprises a seventh switch transistor and an eighth switch transistor, wherein one end of the seventh switch transistor is connected to the second end of the third inductor unit, and the other end of the seventh switch transistor is grounded, and wherein one end of the eighth switch transistor is connected to the second end of the fourth inductor unit, and the other end of the eighth switch transistor is grounded.

7. The five-level power converter according to claim 5, wherein the external input power supply comprises an external alternating current input power supply or a battery group, wherein the external input power supply and the first end of the third inductor unit, as well as the external alternating current input power supply and the first end of the fourth inductor unit, are connected by using an alternating current switch component, wherein the battery group comprises a fifth battery unit and a sixth battery unit, wherein an anode of the fifth battery unit is connected to the first end of the third inductor unit by using a direct current switch component, and a cathode of the fifth battery unit is grounded, and wherein a cathode of the sixth battery unit is connected to the first end of the fourth inductor unit by using a direct current switch component, and an anode of the sixth battery unit is grounded.

8. The five-level power converter according to claim 2, wherein the first inductor unit, the second inductor unit, the third inductor unit, or the fourth inductor unit is formed by a single inductor component, multiple inductor components connected in parallel, or multiple inductor components connected in series.

9. The five-level power converter according to claim 1, wherein the discharge control circuit comprises a ninth switch transistor, a tenth switch transistor, an eleventh switch transistor, a twelfth switch transistor, a thirteenth switch transistor, a fourteenth switch transistor, and a third switching circuit, wherein a first end of the ninth switch transistor is connected to the second end of the first capacitor, a second end of the ninth switch transistor is connected to a first end of the tenth switch transistor, a second end of the tenth switch transistor is connected to the second end of the first inductor unit, a first end of the eleventh switch transistor is connected to the second end of the second capacitor, and a second end of the eleventh switch transistor is connected to the first end of the tenth switch transistor, wherein a first end of the fourteenth switch transistor is connected to the second end of the fourth capacitor, a second end of the fourteenth switch transistor is connected to a first end of the thirteenth switch transistor, a second end of the thirteenth switch transistor is connected to the second end of the first inductor unit, a first end of the twelfth switch transistor is connected to the second end of the third capacitor, and a second end of the twelfth switch transistor is connected to the second end of the fourteenth switch transistor, and wherein a first end of the third switching circuit is connected to the second end of the first inductor unit, and a second end of the third switching circuit is grounded to implement forward conduction from the second end to the first end of the third switching circuit or reverse conduction from the first end to the second end of the third switching circuit by time.

10. A control method for a five-level power converter, comprising: controlling a rectifier control circuit to input a current to a second end of a first capacitor, a second end of a second capacitor, a second end of a third capacitor, and a second end of a fourth capacitor, wherein polarities of charges accumulated at the second end of the first capacitor and the second end of the second capacitor are the same, and the amount of electricity accumulated at the second end of the first capacitor is greater than the amount of electricity accumulated at the second end of the second capacitor, wherein polarities of charges accumulated at the second end of the third capacitor and the second end of the fourth capacitor are the same, and the amount of electricity accumulated at the second end of the fourth capacitor is greater than the amount of electricity accumulated at the second end of the third capacitor, and wherein a polarity of charges accumulated at the second ends of the first capacitor and the second capacitor is opposite to a polarity of charges accumulated at the second ends of the third capacitor and the fourth capacitor; and
controlling a discharge control circuit to discharge sequentially from the second end of the second capacitor, the second end of the first capacitor, the second end of the third capacitor, and the second end of the fourth capacitor of the rectifier, wherein a discharge current flows through a first inductor unit and a first load connected in series, and charging and discharging of any of the first capacitor, the second capacitor, the third capacitor, and the fourth capacitor are staggered.

11. The control method for a five-level power converter according to claim 10, wherein controlling the rectifier control circuit to input the current to the second end of the first capacitor, the second end of the second capacitor, the second end of the third capacitor, and the second end of the fourth capacitor comprises:
controlling a first switching circuit to switch flow of an energy storage current provided by an external input power supply from a first end to a second end of a second inductor unit to store energy for the second inductor unit;
closing the first switching circuit to enable the second inductor unit to charge the first capacitor and the second capacitor, and controlling a duty cycle of a third switch transistor connected in series between the second end of the second capacitor and the second end of the second inductor unit such that the amount of electricity accumulated at the second end of the first capacitor is greater than the amount of electricity accumulated at the second end of the second capacitor;
controlling the first switching circuit to switch the flow of the energy storage current provided by the external input power supply from the second end to the first end of the second inductor unit to store energy for the second inductor unit; and
closing the first switching circuit to enable the second inductor unit to charge the third capacitor and the fourth capacitor, and controlling a duty cycle of a fourth switch transistor connected in series between the second end of the third capacitor and the second end of the second inductor unit such that the amount of electricity accumulated at the second end of the fourth capacitor is greater than the amount of electricity accumulated at the second end of the third capacitor.

12. The control method for a five-level power converter according to claim 10, wherein controlling the rectifier control circuit to input the current to the second end of the first capacitor, the second end of the second capacitor, the second end of the third capacitor, and the second end of the fourth capacitor comprises:
controlling a second switching circuit to switch flow of an energy storage current provided by an external input power supply from a first end to a second end of a third inductor unit to store energy for the third inductor unit;
closing the second switching circuit to enable a second inductor unit to charge the first capacitor and the second capacitor, and controlling a duty cycle of a fifth switch transistor connected in series between the second end of the second capacitor and the second end of the third inductor unit such that the amount of electricity accumulated at the second end of the first capacitor is greater than the amount of electricity accumulated at the second end of the second capacitor;
controlling the second switching circuit to switch the flow of the energy storage current provided by the external input power supply from a second end to a first end of a fourth inductor unit; and
closing the second switching circuit to enable the second inductor unit to charge the third capacitor and the fourth capacitor, and controlling a duty cycle of a sixth switch transistor connected in series between the second end of the third capacitor and the second end of the third inductor unit such that the amount of electricity accumulated at the second end of the fourth capacitor is greater than the amount of electricity accumulated at the second end of the third capacitor.

13. The control method for a five-level power converter according to claim 10, comprising:
controlling an eleventh switch transistor to be constantly conducted, a tenth switch transistor to be in on/off state, a ninth switch transistor to be in turn-off state, and the second capacitor to discharge, wherein a discharge current sequentially flows through the first inductor unit and the first load;
controlling the tenth switch transistor to be constantly conducted, the ninth switch transistor to be in on/off state, the eleventh switch transistor to be constantly conducted, and the first capacitor to discharge, wherein a discharge current sequentially flows through the first inductor unit and the first load;
controlling a third switching circuit to switch to forward conduction from a second end to a first end of the third switching circuit;
controlling a twelfth switch transistor to be constantly conducted, a thirteenth switch transistor to be in on/off state, a fourteenth switch transistor to be in turn-off state, and the third capacitor to discharge, wherein a discharge current sequentially flows through the first inductor unit and the first load;
controlling the thirteenth switch transistor to be constantly conducted, the fourteenth switch transistor to be in on/off state, the twelfth switch transistor to be constantly conducted, and the fourth capacitor to discharge, wherein a discharge current sequentially flows through the first inductor unit and the first load; and
controlling the third switching circuit to switch to reverse conduction from the first end to the second end of the third switching circuit.

14. A control apparatus for a five-level power converter, comprising:
a rectifier control module configured to control a rectifier control circuit to input a current to a second end of a first capacitor, a second end of a second capacitor, a second end of a third capacitor, and a second end of a fourth capacitor, wherein polarities of charges accumulated at the second end of the first capacitor and the second end of the second capacitor are the same, and the amount of electricity accumulated at the second end of the first capacitor is greater than the amount of electricity accumulated at the second end of the second capacitor, wherein polarities of charges accumulated at the second end of the third capacitor and the second end of the fourth capacitor are the same, and the amount of electricity accumulated at the second end of the fourth capacitor is greater than the amount of electricity accumulated at the second end of the third capacitor, and wherein a polarity of charges accumulated at the second ends of the first capacitor and the second capacitor is opposite to a polarity of charges accumulated at the second ends of the third capacitor and the fourth capacitor; and
an inverter control module configured to control a discharge control circuit to discharge sequentially from the second end of the second capacitor, the second end of the first capacitor, the second end of the third capacitor, and the second end of the fourth capacitor of a rectifier, wherein a discharge current flows through a first inductor unit and a first load connected in series, and charging and discharging of any of the first capacitor, the second capacitor, the third capacitor, and the fourth capacitor are staggered.

15. The apparatus according to claim 14, wherein the rectifier control module comprises:
a first rectifier control unit configured to control a first switching circuit to switch flow of an energy storage current provided by an external input power supply from a first end to a second end of a second inductor unit to store energy for the second inductor unit;
a second rectifier control unit configured to turn off the first switching circuit to enable the second inductor unit to charge the first capacitor and the second capacitor, and controlling a duty cycle of a third switch transistor connected in series between the second end of the second capacitor and the second end of the second inductor unit such that the amount of electricity accumulated at the second end of the first capacitor is greater than the amount of electricity accumulated at the second end of the second capacitor;
a third rectifier control unit configured to control the first switching circuit to switch the flow of the energy storage current provided by the external input power supply from the second end to the first end of the second inductor unit to store energy for the second inductor unit; and
a fourth rectifier control unit configured to turn off the first switching circuit to enable the second inductor unit to charge the third capacitor and the fourth capacitor, and control a duty cycle of a fourth switch transistor connected in series between the second end of the third capacitor and the second end of the second inductor unit such that the amount of electricity accumulated at the second end of the fourth capacitor is greater than that accumulated at the second end of the third capacitor.

16. The apparatus according to claim 14, wherein the rectifier control module comprises:
a fifth rectifier control unit configured to control a second switching circuit to switch flow of an energy storage current provided by an external input power supply from a first end to a second end of a third inductor unit to store energy for the third inductor unit;
a sixth rectifier control unit configured to turn off the second switching circuit to enable the second inductor unit to charge the first capacitor and the second capacitor, and controlling a duty cycle of a fifth switch transistor connected in series between the second end of the second capacitor and the second end of the third inductor unit such that the amount of electricity accumulated at the second end of the first capacitor is greater than the amount of electricity accumulated at the second end of the second capacitor;
a seventh rectifier control unit configured to control the second switching circuit to switch the flow of the energy storage current provided by the external input power supply from a second end to a first end of a fourth inductor unit; and
an eighth rectifier control unit configured to turn off the second switching circuit to enable the second inductor unit to charge the third capacitor and the fourth capacitor, and control a duty cycle of a sixth switch transistor connected in series between the second end of the third capacitor and the second end of the third inductor unit such that the amount of electricity accumulated at the second end of the fourth capacitor is greater than the amount of electricity accumulated at the second end of the third capacitor.

17. The apparatus according to claim 14, wherein the inverter control module comprises:
a first inverter control unit configured to control an eleventh switch transistor to be constantly conducted, a tenth switch transistor to be in on/off state, a ninth switch transistor to be in turn-off state, and the second capacitor to discharge, wherein a discharge current sequentially flows through the first inductor unit and the first load;
a second inverter control unit configured to control the tenth switch transistor to be constantly conducted, the ninth switch transistor to be in on/off state, the eleventh switch transistor to be constantly conducted, and the first capacitor to discharge, wherein a discharge current sequentially flows through the first inductor unit and the first load;
a third inverter control unit configured to control the eleventh switch transistor to be constantly conducted, the tenth switch transistor to be in on/off state, the ninth switch transistor to be in turn-off state, and the second capacitor to discharge, wherein a discharge current sequentially flows through the first inductor unit and the first load;
a fourth inverter control unit configured to control a third switching circuit to switch to forward conduction from a second end to a first end of the third switching circuit;
a fifth inverter control unit configured to control a twelfth switch transistor to be constantly conducted, a thirteenth switch transistor to be in on/off state, a fourteenth switch transistor to be in turn-off state, and the third capacitor to discharge, wherein a discharge current sequentially flows through the first inductor unit and the first load;
a sixth inverter control unit configured to control the thirteenth switch transistor to be constantly conducted, the fourteenth switch transistor to be in on/off state, the twelfth switch transistor to be constantly conducted, and the fourth capacitor to discharge, wherein a discharge current sequentially flows through the first inductor unit and the first load;
a seventh inverter control unit configured to control the twelfth switch transistor to be constantly conducted, the thirteenth switch transistor to be in on/off state, the fourteenth switch transistor to be in turn-off state, and the third capacitor to discharge, wherein a discharge current sequentially flows through the first inductor unit and the first load; and
an eighth inverter control unit configured to control the third switching circuit to switch to reverse conduction from the first end to the second end of the third switching circuit.
